(19) United States
(12) Patent Application Publication
(10) Pub. No.: US 2012/0247308 A1
(43) Pub. Date: Oct. 4, 2012

(54) MULTI-FUNCTIONAL POSITION SENSING DEVICE HAVING PHYSICAL PATTERN LAYER

(76) Inventor: Chon-Ming Tsai, Taipei (TW)

(21) Appl. No.: 13/434,857

(22) Filed: Mar. 30, 2012

(30) Foreign Application Priority Data
Apr. 1, 2011 (TW) 100111695

(51) Int. Cl. G10H 5/00

(52) U.S. Cl. 84/658

(57) ABSTRACT

A multi-functional position sensing device includes: a plurality of sensors forming a sensing area to detect characteristic data of a touch object; a physical pattern layer, combined with the sensing area for dividing the sensing area into a plurality of independent blocks; and a control circuit for processing the characteristic data detected by the sensors to generate a position data of the touch object, and transmitting the position data to a host; wherein the host activates at least a corresponding command according to the position data relative to the independent blocks. The physical pattern layer can be replaced according to the application purpose to make the multi-functional position sensing device as an electronic percussion instrument, an electronic keyboard instrument, an add-on touch panel for a desktop display, or a game platform.

### BACKGROUND OF THE INVENTION

1. Field of the Invention

The disclosed embodiments of the present invention relate to a multi-functional position sensing device, and more particularly, to a multi-functional touch sensing device that can be applied to a variety of applications, including an electronic percussion instrument, an electronic keyboard instrument, an add-on touch panel, a game platform, etc.

2. Description of the Prior Art

Please refer to FIG. 1, which is a simplified diagram illustrating a conventional electronic percussion instrument 100 connected to a computer. The electronic percussion instrument 100 is typically laid flat on a desk, played with drumsticks or other similar percussion sticks, and easy to carry. The electronic percussion instrument 100 is connected to a host 102 via a connection cable 101. The host 102 is typically computer equipment such as a notebook/laptop computer, a desktop computer, a server, etc. A universal serial bus (USB) cable is most commonly used for implementing the connection cable 101, which includes power lines and signal lines. Power may be supplied from the host 102 to the electronic percussion instrument 100. The electronic percussion instrument 100 includes a plurality of percussion pads 104 and a plurality of function pads 106. The percussion pad 104 is usually composed of piezoelectric sensors to convert pressure from strike into an electric signal. The percussion pad 104 may also be implemented by a switch, which is composed of conductive rubber, metal plate, etc. for transmitting a corresponding electric signal each time the percussion pad 104 is struck. The structure of the function pad 106 is usually the same as that of the percussion pads 104. The function pad 106 is used to activate a preset special effect or function. After receiving the electric signal from percussion pads 104 or function pads 106, the host 102 plays pre-stored audio data accordingly. Base 103 is typically a rigid structure composed of plastic or metal material. Base 103 may also be a flexible structure composed of a plastic film.

To reduce position shifts and errors at striking, the size of percussion pads 104 and function pads 106 should be as large as possible. Preferably, diameters of the percussion pads 104 and function pads 106 are larger than 100 mm. If three percussion pads 104 are arranged in a straight line as shown in FIG. 1, the length of the electronic percussion instrument 100 needs to be 380 mm (i.e. 15 inches) or longer including the spacing between the percussion pads 104. The shape, size, and position of the electronic percussion instrument 100 are all fixed, which is usually made by molding process in mass production. Therefore, the cost of design change is very expensive, and the choice of models is very limited. In other words, if the users would like to play different types of electronic instruments, they have to spend more money on buying more sets of electronic instruments, such as electronic keyboard instrument.

Please refer to FIG. 2, which is simplified diagram illustrating a conventional electronic keyboard instrument 110 connected to a computer. The electronic keyboard instrument 110 is typically laid flat on a desk, connected to a host 102 via a connection cable 101, and easy to carry. The electronic keyboard instrument 110 includes a plurality of keypads 112 and a plurality of function pads 114. The keypad 112 is typically a switch structure composed of conductive rubber, metal plate, etc. for transmitting a corresponding electric signal each time the keypad 112 is pressed or struck. The keypad 112 may also be implemented by a piezoelectric sensor to convert pressure from pressing or striking into an electric signal. The structure of the function pad 114 is usually the same as that of the keypad 112. The function pad 114 is used to activate a predefined special effect or function when pressed or struck. After receiving the electric signal from the keypads 112 or the function pads 114, the host 102 plays pre-stored audio data accordingly. Base 113 is typically a rigid structure composed of plastic or metal material. Base 113 may also be a flexible structure composed of a plastic film. To facilitate user's operation with fingers, the width of the keypads 112 of the electronic keyboard instrument 110 need to be wider than 20 mm. Because the music scale of the electronic keyboard instrument 110 contains at least 3 octaves and each octave contains 7 white keys arranged in a straight line, the length of the electronic keyboard instrument 110 needs to be at least 430 mm (i.e. 17 inches).

The electronic keyboard instrument 110 has the same problem as the electronic percussion instrument 100. That is, the shape, size, and position of the electronic keyboard instrument 110 are all fixed, which is usually made by molding process in mass production. Therefore, the cost of design change is very expensive and the choice of models is very limited. In addition, the conventional electronic percussion instrument 100 or electronic keyboard instrument 110 is structured by piezoelectric sensors or switch composed of conductive rubber, metal plate, etc. The user has to press or strike the instrument with significant force to generate electric signal. Thus, the instrument is likely to be damaged under normal condition. Moreover, undesirable noise comes out if users press or strike the instrument too hard. But, there is no signal response if users press or strike the instrument too gently. Therefore, the conventional electronic percussion instrument 100 and electronic keyboard instrument 110 face the problems of short service life, poor reliability, low sensitivity, and excessive noise.

Please refer to FIG. 3, which illustrates another prior art of computer musical instrument utilizing a touch display 200. The computer musical instrument includes a desktop display 203, a host 206, two connection cables 202 and 204, a touch panel 205, and a plurality of independent electronic patterns 208 and 210. The desktop display 203 is typically flat-panel type, which is usually a liquid crystal display (LCD), and standing upright on the desk. The host 206 is computer equipment such as a desktop computer, a notebook/laptop computer or a server, and is connected to the desktop display 203 via a connection cable 202, wherein a video graphics array (VGA) cable is most commonly used. The touch panel 205 is put in front of the display area of the desktop display 203. A transparent glass sheet of 2 mm or less thickness is utilized as a substrate of the touch panel 205. In order to detect positions of fingers or other touch objects relative to the display area, resistive, capacitive, or other appropriate sensors are placed on the glass plate to form a flat-type sensing area. The position data is transmitted to the host 206 via the connection cable 204, which is usually a USB cable. As the connection cable 204 includes power lines and signal lines, power may be supplied from the host 206 to the touch panel 205.

The host 206 generates independent electronic patterns 208 and 210 on the desktop display 203 according to a predefined program. The shapes, sizes, and positions of the electronic patterns 208 and 210 as well as the meaning of each pattern has been input to the host 206 in advance. The electronic patterns 208 and 210 divide the sensing area of the touch panel 205 into a plurality of independent blocks through the transparent substrate of the touch panel 205. The positions and sizes of the independent blocks are equal to those of the original patterns. When fingers or other touch objects touch the independent blocks, the host 206 plays the corresponding musical sounds according to the predefined program. Therefore, six electronic patterns 208 shown in FIG. 3 may be set to represent six different percussion surfaces of percussion instruments, such as a bass drum, a snare drum, a cymbal, or other instruments. The two electronic patterns 210 may be set to represent two different special effects.

The shapes, sizes, and positions of the electronic patterns 208 and 210, as well as the musical instrument each pattern represents may be changed easily by simply switching the predefined program of the host 206. For example, the percussion instrument in FIG. 3 may be changed to the electronic keyboard instrument in FIG. 2 only by changing the predefined program to a new one. A musical instrument configured by the touch display 200 has high sensitivity, and there is no problem of excessive noise. To facilitate user's operation, the sizes of the electronic patterns 208 are recommended to be equal to or larger than the percussion pads 104 of the electronic percussion instrument 100 in FIG. 1 and the pads 112 of the electronic keyboard instrument 110 in FIG. 2. Therefore, a desktop display with a diagonal length of 20 inches or more is preferred.

A musical instrument by the touch display 200 really solves the problems of conventional electronic instruments, such as high cost of design change, poor sensitivity, and excessive noise. However, there are still some serious problems of the touch display 200 as a musical instrument. For example, when fingers or other touch objects contact the touch panel 205, the whole touch display 200 may shake back and forth, which is harmful to user's eye health and service life of the touch display. In addition, as the touch display 200 stands upright on the desk, the user has to raise hands to operate the touch penal 205, which makes the hands sore easily. Moreover, portability of the touch display 200 is not good. The last and the most important problem is that the touch display 200 only allows gentle touch and can not be operated with drumsticks or other similar sticks because it is a kind of sophisticated electronic product equipped with fragile glass.

### SUMMARY OF THE INVENTION

Therefore, the first objective of the present invention is to provide a position sensing device to work as an electronic musical instrument connected to a computer. It is easy to change the shapes, sizes, positions of percussion pads or keypads, and types of the electronic musical instrument. In addition, the electronic musical instrument has high sensitivity without problem of excessive noise. The electronic musical instrument may be laid flat on a desk and is easy to carry. More importantly, the electronic musical instrument of the present invention can be an electronic percussion instrument played with drumsticks or other similar sticks, and has long service life as well as excellent reliability.

According to the present invention, an exemplary position sensing device, more particularly a touch sensing device, is disclosed. The exemplary position sensing device includes a plurality of sensors forming a sensing area to detect characteristic data of a touch object; a physical pattern layer, combined with the sensing area for dividing the sensing area into a plurality of independent blocks; and a control circuit for processing the characteristic data detected by the sensors to generate position data of the touch object, and transmitting the position data to a host; wherein the host activates at least a corresponding command according to the position data relative to the independent blocks.

The exemplary position sensing device of the present invention may further include a substrate disposed below the sensing area, and a frame disposed on the periphery of the sensing area. The sensors may be optical image sensors or other appropriate sensors. The physical pattern layer may include some independent patterns to represent the percussion pads, keypads, or function pads. The physical pattern layer is combined with the sensing area to divide the sensing area into some independent blocks, whose sizes and positions are equal to those of the original patterns. Therefore, when touch objects, such as fingers, drumsticks, etc., touch the sensing area, the sensors detect characteristic data of the touch objects. The control circuit processes the characteristic data to generate position data of the touch objects and transmits it to the host. The host plays corresponding audio data or activates other corresponding commands according to the position data.

The physical pattern layer of the position sensing device is replaceable and can be made by low-cost printing method. It's quite easy to change the shapes, sizes, positions of percussion pads or keypads, and types of the electronic musical instrument just by replacing a new physical pattern layer and executing the corresponding computer program. In addition, when touch objects, such as fingers, drumsticks, etc., touch the sensing area, the host activates the predefined program to respond to the position data immediately, and it is unnecessary to press or strike the instrument hard. Therefore, the device has high sensitivity, long service life, excellent reliability, and no problem of excessive noise. The substrate of the exemplary position sensing device of the present invention may be a tough metal plate, a plastic plate, or a transparent acrylic plate. Particularly, a translucent elastic sheet may be disposed on the physical pattern layer. Therefore, the electronic musical instrument implemented by the exemplary position sensing device of the present invention may be an electronic percussion instrument which can be played with drumsticks or other similar sticks.

A second objective of the claimed invention is to provide a position sensing device working as a standalone electronic musical instrument without being connected to a computer. In the exemplary position sensing device of the present invention, sensors detect characteristic data of the touch objects. Control circuit processes the characteristic data to generate position data of the touch objects, and transmits the position data to a host. Functions of the host are to store pre-recorded instrument sounds and other related data, and to execute the predefined program. Therefore, a simple motherboard, which is electrically connected to the control circuit and includes a digital processor, a memory, a small display, and a digital-to-analogue converter, can realize the functions of the host. Accordingly, the exemplary position sensing device of the present invention may operate independently without connection to computer equipment such as a desktop computer, a notebook/laptop computer, or a server.

A third objective of the claimed invention is to provide a position sensing device which may work as an electronic musical instrument or as an add-on touch panel. The switching process is quite easy. As mentioned above, the physical pattern layer of the exemplary position sensing device of the present invention is replaceable, and the transparent acrylic plate can be used as the substrate. After removing the whole physical pattern layer and putting the substrate in front of a display connected to the host, electronic patterns on the display area appear clearly to the viewers through the transparent substrate. Therefore, the host generates independent electronic patterns on the display according to the predefined program. The shapes, sizes, and positions of the independent electronic patterns as well as the meaning of each pattern are pre-input to the host. Through the transparent substrate, the electronic patterns divide the sensing area on the substrate into a plurality of independent blocks whose shapes, sizes, and positions are equal to those of the original patterns. When fingers or other touch objects touch the independent blocks, the host activates corresponding commands according to the predefined program. The exemplary position sensing device of the present invention thus becomes an add-on touch panel disposed in front of the display, wherein the sensing area is larger than the display area of the display.

A last objective of the claimed invention is to provide a position sensing device which may be a game platform connected to a computer or a standalone game console. In addition to a musical instrument pattern, the physical pattern layer of the exemplary position sensing device of the present invention may be printed with a playground pattern. The playground pattern includes two patterns representing gates. When a ball moves in the sensing area, the ball position is easily detected by the sensor, and then transmitted to the host after processed by the control circuit. The host calculates the track of the ball and determines the scores according to the predefined program, which makes the exemplary position sensing device of the present invention as a game platform connected to the computer. In addition, the functions of the host may be realized by a simple motherboard, which makes the exemplary position sensing device of the present invention as a standalone game console.

In summary, as an electronic musical instrument the position sensing device of the present invention solves the problems of a conventional electronic musical instrument, such as difficulty of design change, low sensitivity, excessive noise, short service life, poor reliability, etc. Also, the position sensing device of the present invention avoids many disadvantages of a conventional computer musical instrument implemented by a desktop touch display. For example, users' hands tend to get sore, the screen shakes back and forth, and the instrument can't be struck, in addition to poor portability, poor reliability, and short service life. Moreover, the position sensing device of the present invention supports multiple functions, which may be utilized as an add-on touch panel or a game platform besides different kinds of electronic musical instruments. Therefore, compared to the conventional designs, the present invention does have patentability.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram illustrating a conventional electronic percussion instrument.

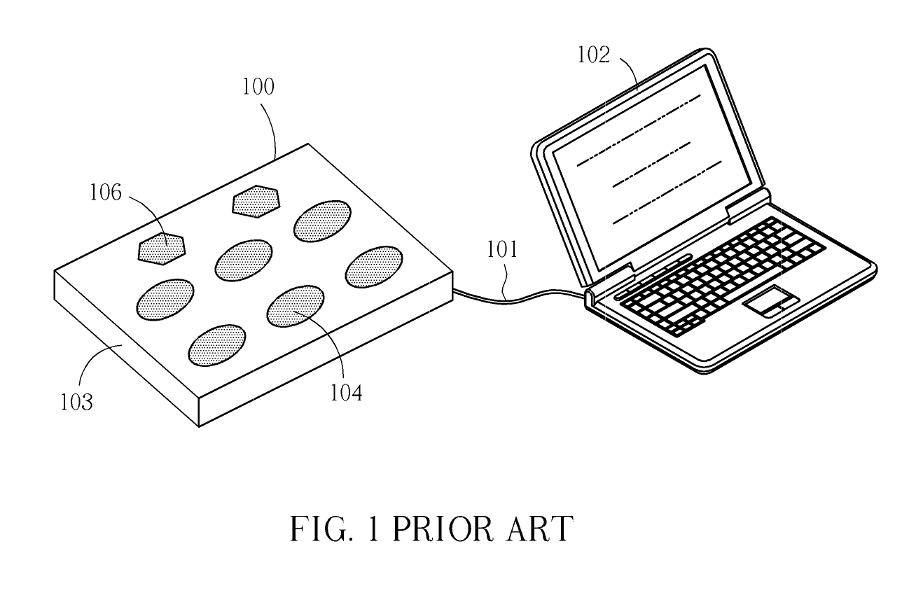

FIG. 2 is a simplified diagram illustrating a conventional electronic keyboard instrument.

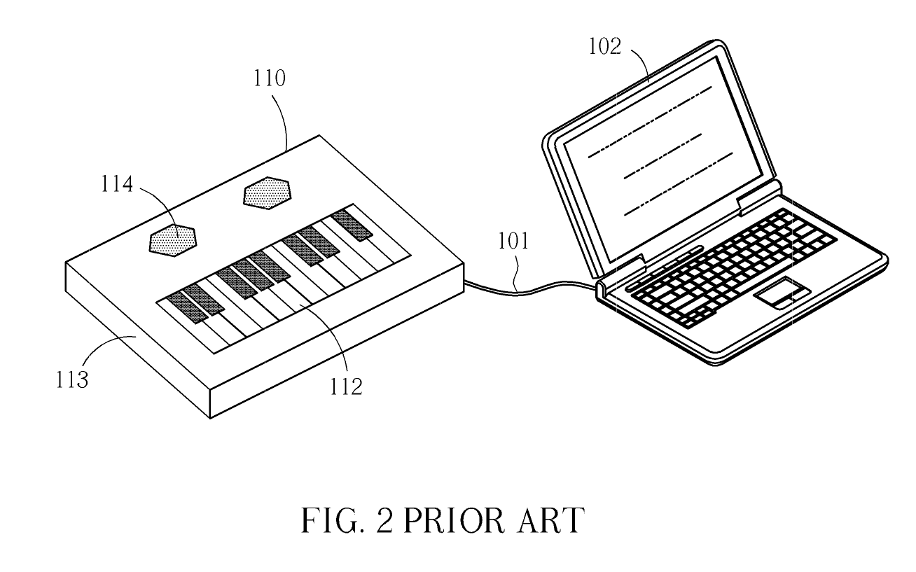

FIG. 3 is a simplified diagram illustrating a conventional desktop touch display.

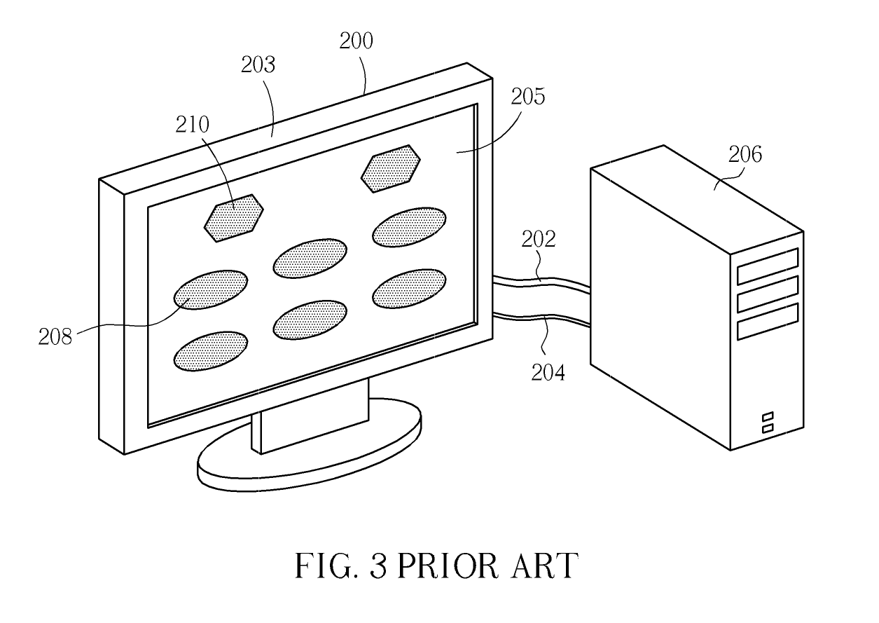

FIG. 4 is a diagram illustrating an exemplary embodiment of the present invention.

FIG. 5 is a diagram illustrating a position sensing principle according to an exemplary embodiment of the present invention.

FIG. 6 is a diagram illustrating a cross section according to an exemplary embodiment of the present invention.

FIG. 7A-7D are diagrams illustrating an implementation method according to an exemplary embodiment of the present invention.

FIG. 8 is a diagram illustrating a calibration method according to an exemplary embodiment of the present invention.

FIG. 9 is a diagram illustrating a cross section according to another exemplary embodiment of the present invention.

FIG. 10 is a diagram illustrating a standalone electronic musical instrument according to an exemplary position sensing device of the present invention.

FIG. 11 is a block diagram according to an exemplary position sensing device of the present invention.

FIG. 12 is a diagram illustrating an add-on touch panel according to an exemplary position sensing device of the present invention.

FIG. 13 is a diagram illustrating a game platform according to an exemplary position sensing device of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

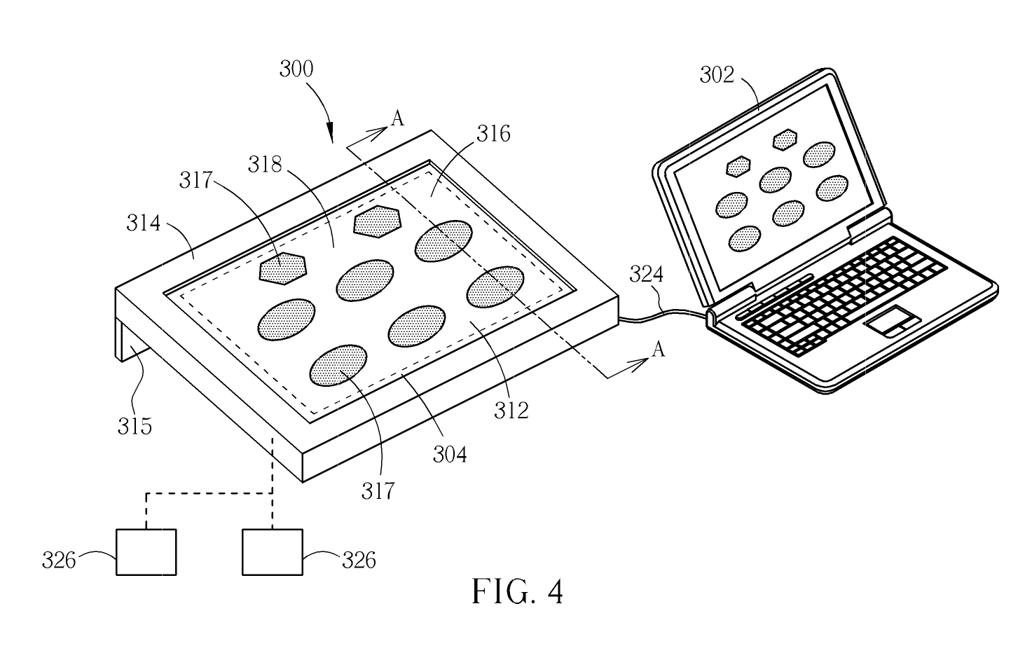

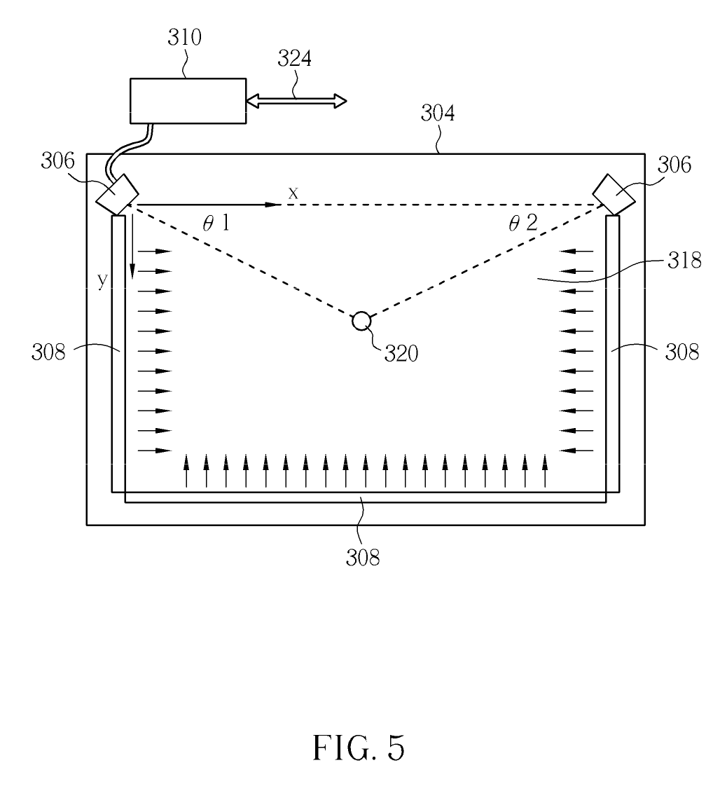

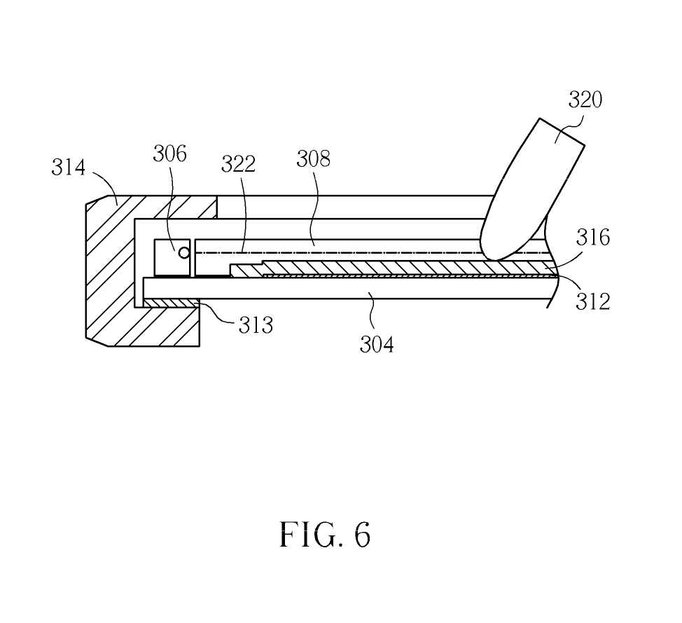

Please refer to FIG. 4, FIG. 5, and FIG. 6 together. FIG. 4 is a simplified diagram illustrating an exemplary position sensing device 300 according to an embodiment of the present invention. FIG. 5 is a diagram illustrating a sensing principle of the exemplary position sensing device 300. FIG. 6 is a diagram illustrating a cross section of the exemplary position sensing device 300 along the direction A-A, wherein the exemplary position sensing device 300 is an electronic musical instrument electrically connected to a computer. As shown in FIG. 4, the exemplary position sensing device 300 includes a substrate 304, a physical pattern layer 312, a sensing area 318, a translucent elastic sheet 316, and a frame 314. The substrate 304 is typically a rectangular plate, which may be an opaque metal/plastic plate, or a transparent acrylic/high-strength glass plate. The physical pattern layer 312, typically put on the substrate 304, may contain patterns with a variety of sizes and colors, and may be changed according to application purposes. The physical pattern layer 312 may be formed by printing, engraving, or molding, wherein printing is the most economical way. A plurality of patterns 317 representing percussion pads and function pads of the instrument are printed on paper, plastic, or other appropriate sheet, which is 0.05-0.3 mm thick typically. Patterns 317 of the physical pattern layer 312 may also be printed or laser engraved directly on the surface of the substrate 304. The sensing area 318, formed by a plurality of sensors over the physical pattern layer 312, is wide enough to cover all patterns on the physical pattern layer 312. The flat and translucent elastic sheet 316 covers and protects the physical pattern layer 312, disperses the stress, and reduces the noise when struck. The frame 314, typically a rectangular one, is set on the periphery of the substrate 304 and the sensing area 318, and is a rigid structure composed of plastics or metal. The frame 314 may include a stand 315 used to adjust the gradient of the exemplary position sensing device 300, and the stand 315 may include a rubber pad in contact with the desk for damping vibration. The exemplary position sensing device 300 may further include at least an external switch 326, wherein a pedal switch is most applicable. In this way, the proposed device can also be operated with feet, in addition to hands.

The exemplary position sensing device 300 is connected to a host 302 via a connection cable 324. The host 302 is typically a computer equipment such as a notebook/laptop computer, a desktop computer, or a server, where the display area usually has an aspect ratio of 16:9. A USB cable is most popular for implementing the connection cable 324, which includes power lines and signal lines so that 5V power may be supplied from the host 302 to the exemplary position sensing device 300. The shape, size, and position of each pattern 317 on the physical pattern layer 312 as well as the function of the each pattern 317 are input to the host 302 in advance. The physical pattern layer 312 is positioned below the sensing area 318, and is clearly visible to users through the translucent elastic sheet 316. The physical pattern layer 312 divides the sensing area 318 into a plurality of independent blocks whose sizes and positions are equal to those of the original patterns 317. For example, six oval blocks represent percussion pads, two hexagonal blocks represent function pads, and a blank block has no functions. Therefore, when touch objects, such as fingers, drumsticks, etc., touch one of the independent blocks of the sensing area 318, the host 302 plays a corresponding musical sound or activates other corresponding command according to the predefined program.

FIG. 5 is a diagram illustrating a sensing principle of the exemplary position sensing device 300 by optical image technique. The exemplary position sensing device 300 includes two sensors 306 disposed respectively on the upper-left and upper-right corners of the substrate 304; three light bars 308 disposed respectively on the left, right, and bottom sides of the substrate 304; and a control circuit 310 electrically connected to the sensors 306. Each of the sensors 306 is mainly composed of a sensing chip and a lens. The sensing chip is fabricated by semiconductor technology to include many tiny light sensing cells in a linear or planar area array. The lens, whose viewing angle is 90 degree or larger, is put in front of the sensing chip to reduce the objects within the viewing angle onto the sensing chip. The light bars 308 are mainly composed of acrylic light guides and infrared light emitting diodes (LEDs). Two infrared light emitting diodes are fixed respectively to the two ends of the acrylic light guides to emit light. The infrared light is guided toward the inside of the substrate 304, as indicated by the arrow symbols shown in FIG. 5. Infrared light with wavelength of 850 nm or 940 nm is most commonly used, which is invisible to human eyes but can be detected by the sensors 306. Therefore, viewing angles of the two sensors 306 together with the illuminated areas of the three light bars 308 define the sensing area 318. As shown in FIG. 5, the sensing area 318 is a rectangle whose length equals the distance between the front ends of the two sensors 306, and whose height is about the length of the light bar 308 on the right side or left side.

The control circuit 310 is electrically connected to the sensors 306 to supply power and driving signals to the sensors 306 and the light bars 308. The upper-left sensor 306 detects the infrared light from the light bars 308 disposed on the right and bottom sides. The upper-right sensor 306 detects the infrared light from the light bars 308 disposed on the left and bottom sides. The infrared light makes the outputs of the two sensors 306 at high levels. When a touch object 320, such as a finger or a drumstick, touches the sensing area 318, partial infrared light is blocked and outputs of some light sensing cells of the two sensors 306 drop to low levels respectively. The control circuit 310 processes the data transmitted from the two sensors 306, and calculates the start and end light sensing cells whose outputs drop to low levels. According to such characteristic data, the control circuit 310 finds out center line of the touch object 320, and determines an included angle between the center line and the line joining the two sensors. θ1 is the included angle detected by the upper-left sensor 306, and θ2 is the included angle detected by the upper-right sensor 306. The cross point of the two angles of θ1 and θ2 is the center of the touch object 320. The center can be transformed into a linear value (x, y) by appropriate mathematical formulas, where the front end of the upper-left sensor 306 is specified as the origin, the line joining front ends of the two sensors 306 is specified as the horizontal axis, and the vertical axis is perpendicular to the horizontal axis. Then, the control circuit 310 transforms the center position of the touch object 320 into appropriate format and transmits it to the host 302 via connection cable 324.

Please refer to FIG. 6. The center line 322 of the sensing area is over the physical pattern layer 312 and the elastic sheet 316. The exemplary position sensing device 300 of the present invention further includes a buffer layer 313, disposed between the substrate 304 and the frame 314, for damping vibration to protect the sensors 306 and the light bars 308. The service life and the reliability of the exemplary position sensing device 300 are thereby enhanced. The buffer layer 313 may include buffer materials such as rubber, foam, spring, gas, or elastic plastic.

With regard to the optical image sensing technique, a related method is disclosed in U.S. Pat. No. 4,144,449, where two linear image sensors placed on the upper-left and upper-right corners of the screen detects touch position of fingers on the screen. As the sensors and the light bars have to be placed on top of the display to increase overall thickness significantly, they are not applicable for portable devices with small-size displays. However, the optical image sensing technique is very suitable to large-size applications such as desktop displays because of cost advantage and thickness increase from the sensors and light bars is less significant.

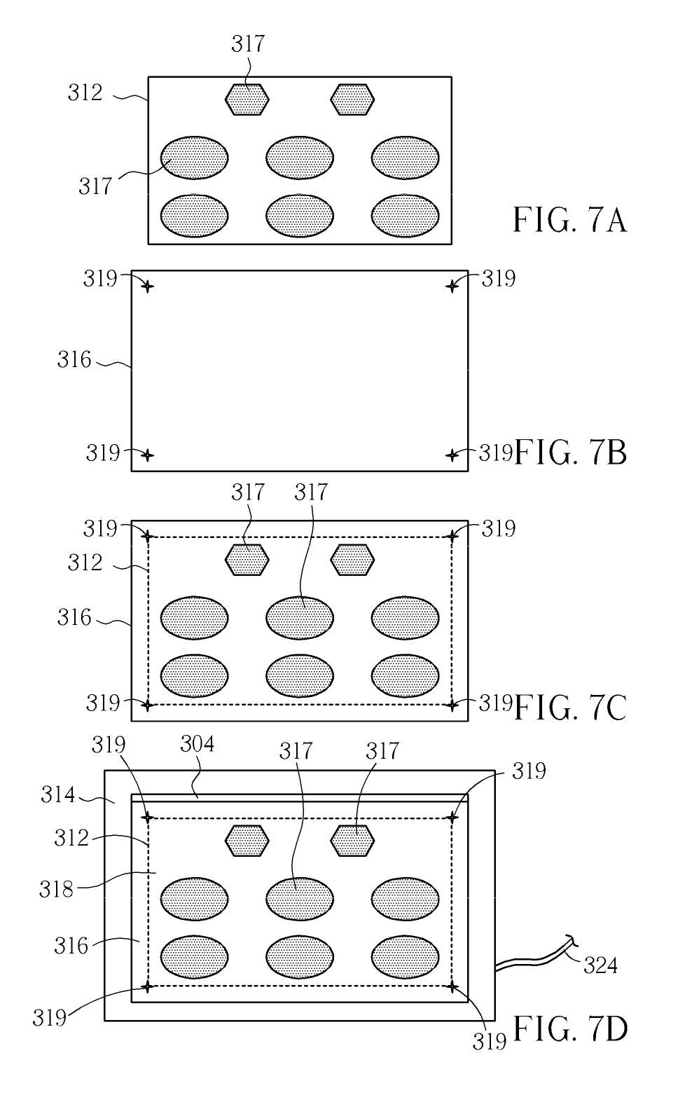

Please refer to FIG. 7A to 7D, which are diagrams illustrating an implementation method of the exemplary position sensing device 300 according to the present invention. It is very easy to replace the physical pattern layer 312 according to different purposes. FIG. 7A is a diagram illustrating the physical pattern layer 312, FIG. 7B is a diagram illustrating the elastic sheet 316, and FIG. 7C is a diagram illustrating a combination of the physical pattern layer 312 and the elastic sheet 316. FIG. 7D is a simplified diagram illustrating the sensing area 318 associated with the combination of the physical pattern layer 312 and the elastic sheet 316. As shown in FIG. 7A, the physical pattern layer 312 contains patterns 317, which are printed on a sheet of paper or plastic to represent percussion pads and function pads of the instrument. The thickness of the sheet is about 0.1 mm, and the aspect ratio of the sheet is 16:9. The translucent elastic sheet 316 shown in FIG. 7B is preferably made of silicone material with thickness of about 1 mm to 3 mm. The aspect ratio of the elastic sheet 316 is 16:9. The size of the elastic sheet 316 may be slightly smaller than that of the sensing area 318. In addition, the elastic sheet 316 may include four alignment marks 319, which coincide with the four corners of the physical pattern layer 312 respectively. Therefore, it is quite easy to bond the physical pattern layer 312 to the elastic sheet 316 precisely as shown in FIG. 7C. Because the silicone material is somewhat sticky in nature, the physical pattern layer 312 may be bonded to the elastic sheet 316 directly, or by assistance of some appropriate tape. The bonded physical pattern layer 312 and the elastic sheet 316 are then put on top of the substrate 304, as shown in FIG. 7D.

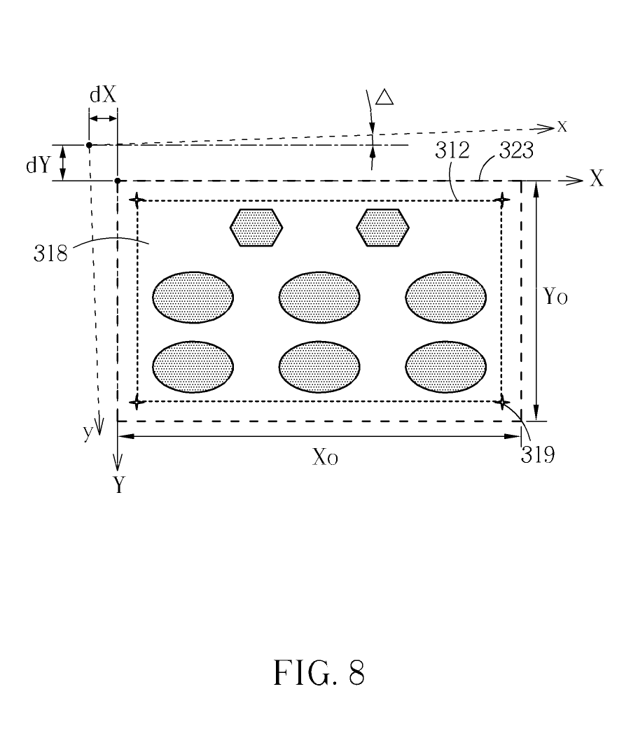

Next, calibration and coordinate conversion are performed so that the host 302 can precisely identify the position of any pattern 317 on the physical pattern layer 312. Please refer to FIG. 8, which is a diagram illustrating calibration and coordinate conversion of the exemplary position sensing device 300 according to the present invention. Xo and Yo are the length and width of an ideal sensing area 323 of the exemplary position sensing device 300. For the application of a 22-inch diagonal dimension, Xo and Yo are 480 mm and 270 mm respectively, and the aspect ratio is 16:9. The length and the width of the physical pattern layer 312 may be designed to be 90% of Xo and Yo (i.e. 432 mm and 243 mm). The ideal sensing area 323 and the physical pattern layer 312 are parallel and coincide in the centers. The position of the exemplary position sensing device 300 is measured by mm, while the display of the host 302 is measured by a pixel. Taking a common notebook computer for example, the display area has 1366*768 pixels for aspect ratio of 16:9. To convert the ideal sensing area 323 to the display area of the display, the conversion factor is 2.85 pixel/mm (i.e. 1366 pixel/480 mm or 768 pixel/270 mm). Therefore, supposing that the upper-left corner of the ideal sensing area 323 is set as an origin, it is easy to convert any position of the pattern 317 on the physical pattern layer 312 to a position in the display area if the upper-left corner of the display area is set as the origin too.

As shown in FIG. 5, the front end of the upper-left sensor 306 is set as the origin of the actual sensing area 318. The line joining the front ends of the upper-left and upper-right sensors 306 is thus specified as the horizontal axis, and the vertical axis is perpendicular to the horizontal axis. There is an offset between the actual sensing area 318 and the ideal sensing area 323. The offset may come from an assembly tolerance of the two sensors 306, bonding shift between the physical pattern layer 312 and the elastic sheet 316, or placement deviation between the physical pattern layer 312 and the sensing area 318. It is thus necessary to identify and compensate the offset value. As shown in FIG. 8, the calibration procedure is mainly to find the horizontal displacement of the origin dX, the vertical displacement of the origin dY, and the rotating angle Δ of the coordinate axes. Based on the four-point calibration method which is commonly used in industry, a finger or other appropriate object is first put on the four corners of the physical pattern layer 312 (i.e. the four alignment marks 319 of the elastic sheet 316) sequentially. The exemplary position sensing device 300 of the present invention reads out four corresponding position data, respectively, and then calculates the three parameters dX, dY, and Δ according to a well-known formula in industry. Therefore, any coordinate (x, y) in the actual sensing area 318 is able to be successfully converted into the corresponding coordinate (X, Y) in the ideal sensing area 323. The control circuit 310 then converts the coordinate (X, Y) to the corresponding horizontal and vertical pixels of the display according to the default conversion factor (e.g., 2.85 pixel/mm), and transmits the horizontal and vertical pixels to the host 302.

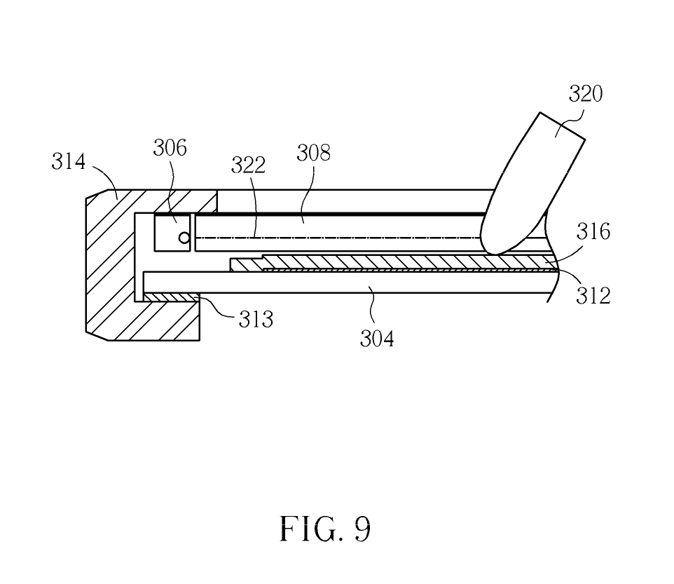

Please refer to FIG. 9, which is a diagram illustrating another exemplary implementation method of the exemplary position sensing device 300 according to the present invention. The sensors 306 and the light bars 308 are disposed on the frame 314 and separated from the substrate 304. The physical pattern layer 312 and the translucent elastic sheet 316 are put on top of the substrate 304 and located under the sensing area 318. The buffer layer 313 is disposed between the substrate 304 and the frame 314 for damping vibration of the substrate 304. The buffer layer 313 may include buffer materials such as rubber, foam, spring, gas, or elastic plastic. Because the sensors 306 and the light bars 308 are separated from the substrate 304, they will not be struck directly when fingers, drumsticks, or other touch objects press or strike the elastic sheet 316, the physical pattern layer 312 and the substrate 304. Because vibration of the substrate 304 is isolated effectively, the service life and the reliability of the exemplary position sensing device 300 of the present invention are further improved.

In other embodiments, the exemplary position sensing device 300 of the present invention may be realized by resistive sensors, capacitive sensors, or infrared sensors. The resistive sensor is implemented by bonding together two plastic films having resistive layers which are spaced apart by many small insulating particles. After touched, the resistive layers of the two plastic films contact each other to generate a resistive output which is unique to each touch position. So, the touch position may be obtained by measuring the resistive output. The advantage of the resistive sensor is that it can be used under all kinds of climates and environments. In addition, as the resistive sensor is made of plastic films, it may be bonded to a substrate with flat or curved surfaces. The disadvantage of the resistive sensor is that the reliability is not good after repeated touches.

The capacitive sensor is typically made by bonding two layers of metal pattern isolated by a very thin dielectric layer. Each layer of metal pattern has many identical patterns arranged regularly. The two layers are interlaced, where one layer performs the horizontal detection and the other performs the vertical detection. When fingers or other touch objects approach or touch the patterns, capacitance values are changed so that the sensor thus obtains the corresponding touch positions. High sensitivity is the major advantage of the capacitive sensor. The disadvantage is that cost is high and an insulated touch object can not be detected.

The infrared sensor has many infrared LEDs to form light bars located at bottom and one side of the sensing area. The bottom one represents horizontal direction, and the side one represents vertical direction. Many infrared receivers are located at top and the other side of the sensing area. The infrared LEDs and receivers have the same spacing and quantity. The infrared LEDs and receivers are paired one-to-one and activated in turn from the first pair. Please note that only one pair remains activated. The receiver's output becomes higher as the intensity of the infrared light increases. As fingers or other touch objects in the sensing area intercept the infrared light, the output of the corresponding receiver drops down. The horizontal and vertical positions of the touch objects are therefore obtained. The advantage of the infrared sensor is that there is no contact between the sensor and the touch objects because the sensor is located at the periphery of the sensing area. The disadvantage is that cost is high and it is not applicable in an environment with higher infrared intensity, such as an outdoor application.

In other embodiments of the present invention, the exemplary position sensing device 300 may be a standalone electronic musical instrument without being connected to a computer. The exemplary position sensing device 300 of the present invention forms the sensing area 318 by the sensors 306 to detect characteristic data of touch objects such as fingers or drumsticks, and transmits position data of the touch objects to the host 302 after the control circuit 310 processes the characteristic data. The host 302 plays the corresponding audio data or activates other corresponding commands according to the position data by executing the predefined program. The functions of the host 302 are to store the pre-recorded audio data and other related data, and to execute the predefined program. Therefore, a simple motherboard electrically connected to the control circuit 310 is able to accomplish the functions of the host 302 of the exemplary position sensing device 300 of the present invention.

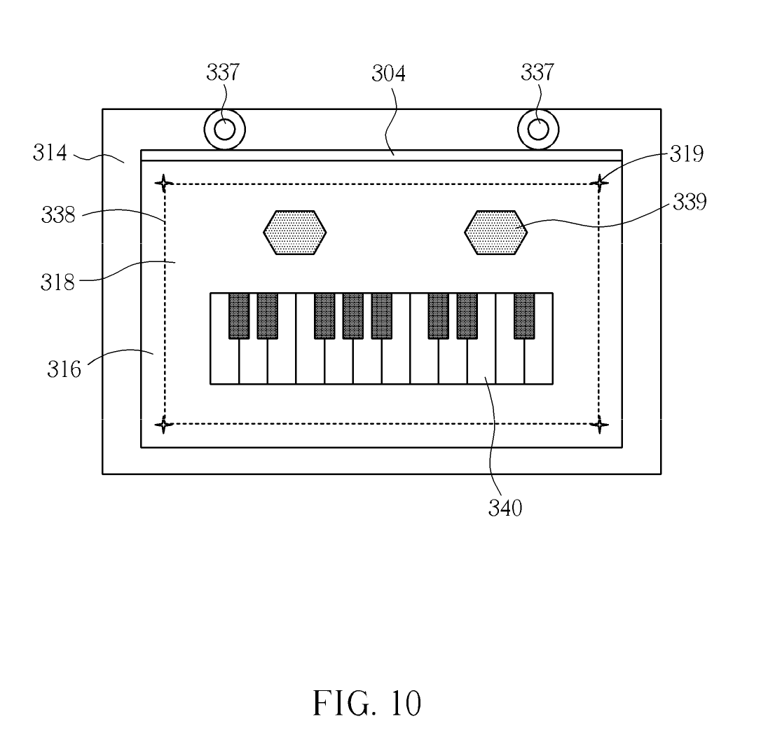

FIG. 10 is a diagram illustrating the exemplary position sensing device 300 acting as a standalone electronic musical instrument according to the present invention. The physical pattern layer 312 may be replaced by another pattern layer 338. In addition to the substrate 304, the translucent elastic sheet 316, the sensing area 318, and the frame 314, the exemplary position sensing device 300 further includes two speakers 337 and a motherboard 350 (not shown). The pattern layer 338 includes patterns 340 representing keypads and patterns 339 representing function pads. The pattern layer 338 divides the sensing area 318 into a plurality of independent blocks with positions and sizes equal to those of the original patterns 340 and 339. When fingers or other touch objects press any pattern 340 or 339, the motherboard 350 plays the corresponding audio data through the speakers 337 or activates other corresponding command by executing the predefined program.

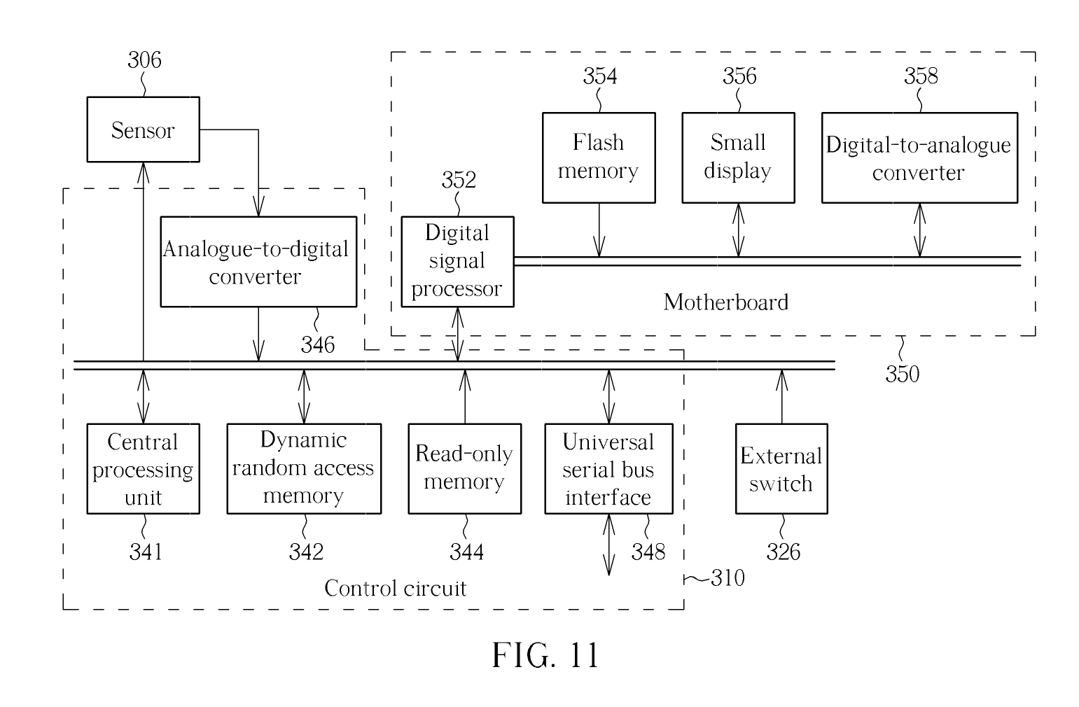

Please refer to FIG. 11, which is a block diagram illustrating the exemplary position sensing device 300 acting as a standalone electronic musical instrument according to the present invention. The exemplary position sensing device 300 includes the control circuit 310 and the motherboard 350. The control circuit 310 includes a central processing unit (CPU) 341, a dynamic random access memory (DRAM) 342, a read-only memory (ROM) 344, an analogue-to-digital converter (ADC) 346, and a universal serial bus interface 348. The CPU 341 is used to provide driving signals to the sensors 306 and process characteristic data detected by the sensors 306 to generate corresponding position data. The ADC 346 is used to convert analogue output signals of the sensors 306 to digital signals executable for the CPU 341. The ROM 344 is used to store algorithmic software data. The DRAM 342 is used to temporarily store the related data under execution. The universal serial bus interface 348 is used to transmit the position data, which has been processed by the CPU 341, to the host 302. An external switch 326 is used to provide control signals to the CPU 341 if needed. The motherboard 350 includes a digital signal processor (DSP) 352, a flash memory 354, a small display 356, and a digital-to-analogue converter (DAC) 358. The DSP 352 receives the position data from the CPU 341, and activates at least a corresponding command such as playing the audio data pre-stored in the flash memory 354. The flash memory 354 is used to pre-store the predefined audio data, programs, and other related data. The small display 356 may be an LED display or a small LCD screen used for selecting or showing the serial number of the program. The DAC 358 is used to convert digital signals to analogue signals for driving an output apparatus such as the speaker 337. In this embodiment, due to the use of the motherboard 350, the exemplary position sensing device 300 becomes a standalone electronic musical instrument without being connected to an external host. In addition, the exemplary position sensing device 300 can be an electronic musical instrument connected to computer equipment just by disabling the motherboard 350.

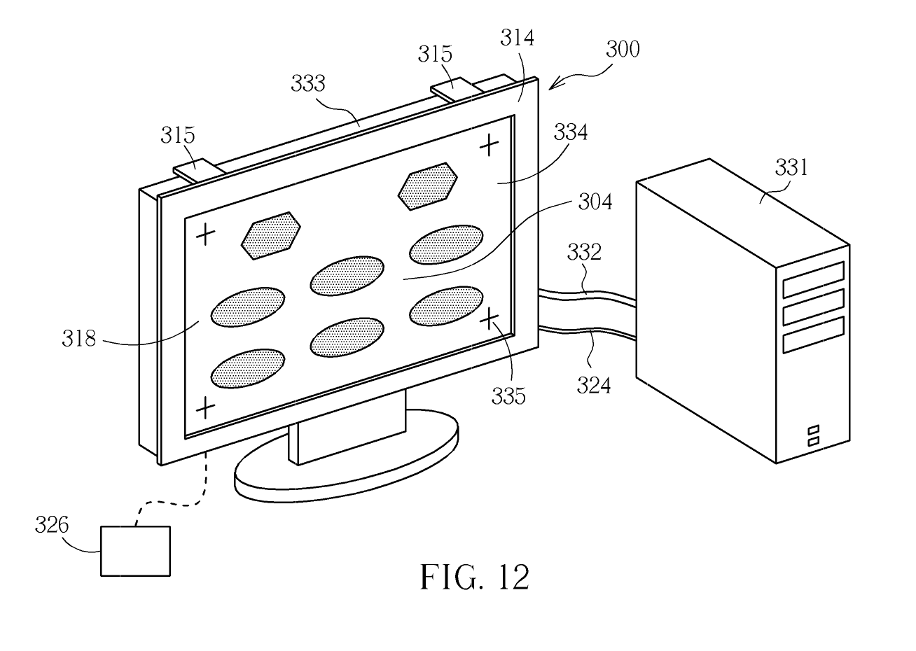

Please refer to FIG. 12, which is a diagram illustrating another implementation of the exemplary position sensing device 300 according to the present invention. For example, the exemplary position sensing device 300 may be an add-on touch panel. The exemplary position sensing device 300 of the present invention may be either an electronic musical instrument or an add-on touch panel, and the transformation between them is very easy. As mentioned above, the substrate of the exemplary position sensing device 300 of the present invention may be an opaque metal/plastic plate, or a transparent acrylic/high-strength glass plate. The physical pattern layer 312 of the exemplary position sensing device 300 of the present invention is replaceable, and it is very easy to remove the whole physical pattern layer 312 and the upper elastic sheet 316. Therefore, the exemplary position sensing device 300 of the present invention may become an add-on touch panel by using a transparent substrate and removing the physical pattern layer 312. The add-on touch panel is put in front of a display 333 connected to a host 331. The host 331 may be a desktop computer, a notebook/laptop computer, or a server. The display 333 is connected to the host 331 via a connection cable 332, which is usually a VGA cable. The exemplary position sensing device 300 of the present invention includes a substrate 304, a sensing area 318, a frame 314, and two support elements 315, and is connected to the host 331 via a connection cable 324. The substrate 304 is a transparent substrate, such as a transparent acrylic or a high-strength glass plate, put in front of the display 333. The two support elements 315 are linked to the frame 314, and placed on the top edge of the display 333 to support the weight of the whole device 300. Plastic screws or other adjusting mechanisms may be formed on the support elements 315 to adjust the height of the sensing area 318 relative to the display area 334. The USB cable is most commonly used for implementing the connection cable 324. As the connection cable 324 includes power lines and signal lines, 5V power may be supplied from the host 331 to the exemplary position sensing device 300.

The sensing area 318 is in front of the substrate 304, and the size of the sensing area 318 is larger than that of the display area 334 of the display 333. It is necessary to perform calibration and conversion so that the sensing area 318 will match the display area 334 precisely. The calibration and conversion methods are the same as those shown in FIG. 8, where the display area 334 of the display 333 is equivalent to the ideal sensing area 323. The calibration procedure is mainly to find the horizontal displacement of the origin dX, the vertical displacement of the origin dY, and the rotating angle Δ of the coordinate axes between the actual sensing area 318 and the display area 334. Four calibration points 335 are generated by the host 331. A rectangle formed by the four calibration points 335 is parallel to the sensing area 334, and central points of both are the same. Based on the four-point calibration commonly used in industry, a finger or other appropriate object is put on the four calibration points 335 sequentially, and then the exemplary position sensing device 300 reads out four corresponding coordinates respectively to calculate the three parameters dX, dY, and Δ accordingly. Therefore, any coordinate (x, y) in the actual sensing area 318 is able to be successfully converted to the corresponding coordinate (X, Y) in the display area 334. Next, the coordinate (X, Y) is converted to the horizontal and vertical pixels of the display according to the pre-input conversion factor. For a 22-inch display with a 16:9 aspect ratio, the length and width are 480 mm and 270 mm, respectively. If the display area of the display has 1366*768 pixels, the conversion factor is 2.85 pixel/mm (i.e. 1366 pixel/480 mm or 768 pixel/270 mm).

Therefore, electronic patterns generated by the host 331 according to predefined program and displayed on the display area 334 would appear clearly through the transparent substrate 304. Specifically, the host 331 generates a plurality of independent electronic patterns on the display according to the predefined program, where the shape, size, position, and function of each pattern have been pre-input to the host 331. Through the transparent substrate, the electronic patterns divide the sensing area over the substrate into a plurality of independent blocks whose positions and sizes are equal to those of the original patterns. When fingers or other touch objects touch the independent blocks, the host 331 activates the corresponding commands according to the predefined program. The exemplary position sensing device 300 of the present invention thus becomes an add-on touch panel placed in front of the display 333.

To sum up, the exemplary position sensing device 300 of the present invention employs a transparent substrate, and the physical pattern layer 312 has physical patterns formed by printing or other methods. The exemplary position sensing device 300 may be laid flat on the desk as an electronic musical instrument. After removing the physical pattern layer 312, the exemplary position sensing device 300 may be placed in front of the display 333 as an add-on touch panel, where electronic patterns on the display 333 represent the physical pattern layer 312.

As an add-on touch panel, the exemplary position sensing device 300 of the present invention may further include an external switch 326 that can be operated by hands or feet. The objective is to provide another control signal source besides touch-based signals. As the sensing area 318 of the exemplary position sensing device 300 of the present invention is disposed over the substrate 304, the position data of the touch objects has been transmitted to the host 331 for execution of the corresponding commands before the touch objects fully touch the substrate 304. Such sensing method is very sensitive, and is therefore good for application of electronic musical instrument. However, it is disadvantageous for some operations requiring fine alignment. Without auxiliary tools, wide tolerance would occur when a user touches or draws tiny patterns by hands. It would be much better that the touch position could be fine tuned per requirement. Therefore, the external switch 326 may be configured to be a touch confirmation switch. Therefore, the host 331 will execute the preset commands only if both the position data and the signal of the external switch 326 are received. Thus, the user may adjust touch positions on the substrate 304, and trigger the external switch 326 if the touch position is satisfactory.

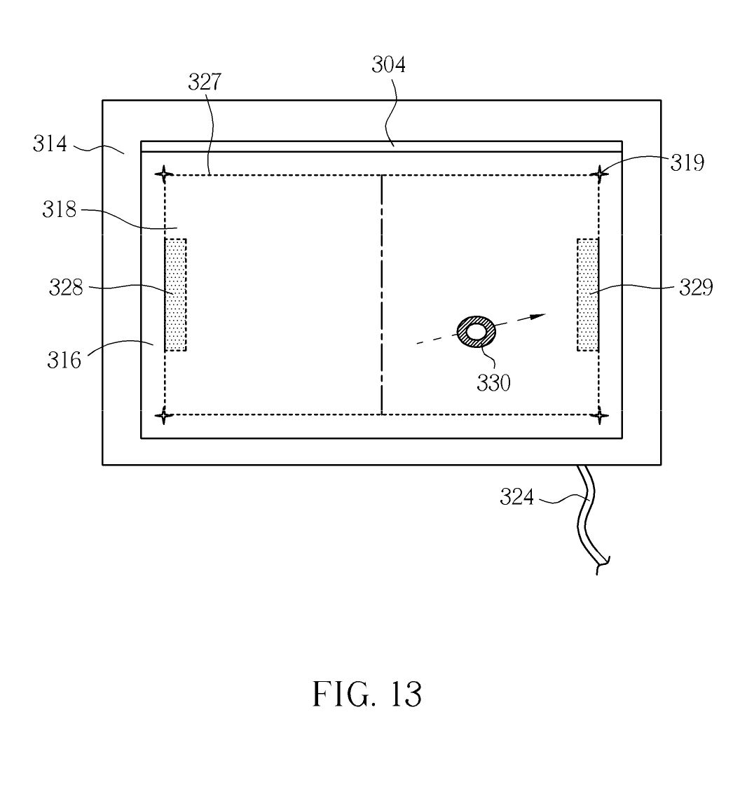

The above embodiments are for illustrative purposes only, and are not meant to be limitations of the present invention. The pattern layer of the exemplary position sensing device of the present invention is replaceable, and the pattern layer may be changed to represent different electronic musical instruments. Similarly, the pattern layer may be changed for applications besides musical instruments, such as games. FIG. 13 is a diagram illustrating the exemplary position sensing device 300 as a game application. The exemplary position sensing device 300 includes a substrate 304, a pattern layer 327, a translucent elastic sheet 316, a sensing area 318, a frame 314, and a connection cable 324. The pattern layer 327 includes patterns 328 and 329 representing gates, and the elastic sheet 316 is put on the pattern layer 327. A real ball 330 moves on the elastic sheet 316. Positions of the ball 330 (relative to the patterns 328 and 329) can be detected by the exemplary position sensing device 300, and the position data is transmitted to the host 302 (not shown) via the connection cable 324. The host 302 calculates the track of the ball 330 and determines the scores according to the predefined program. For example, when the ball 330 passes the pattern 328 which represents the left-side gate, the host 302 counts that the right-side player scores. Therefore, the exemplary position sensing device 300 becomes a game platform, and it is easy to change game types by replacing both the pattern layer 327 and the program executed by the host 302. Similar to application of the electronic musical instrument, the exemplary position sensing device 300 of the present invention may further include a motherboard 350 (not shown) for storing data and program to be executed. The exemplary position sensing device 300 therefore serve as a standalone game console without being connected to an external host.

In summary, the position sensing device of the present invention may act as an electronic musical instrument, thereby solving problems of a conventional electronic musical instrument, such as difficulty of design change, low sensitivity, excessive noise, short service life, poor reliability, etc. It also avoids many disadvantages of a conventional musical instrument of desktop touch display, such as soring hands, shaken screen, poor portability, and fragility as a percussion instrument. In addition, the position sensing device of the present invention supports multiple functions, and may be utilized as an add-on touch panel and a game platform besides different kinds of electronic musical instruments. Therefore, compared to the conventional designs, the present invention does have patentability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A position sensing device, comprising:
a plurality of sensors, forming a sensing area utilized to detect characteristic data of a touch object;
a physical pattern layer, combined with the sensing area for dividing the sensing area into a plurality of independent blocks; and
a control circuit, electrically connected to the sensors, for processing the characteristic data detected by the sensors to generate position data of the touch object, and transmitting the position data to a host;
wherein the host activates at least a corresponding command according to the position data relative to the independent blocks.

2. The position sensing device of claim 1, wherein the sensors comprise optical image sensors, resistive sensors, capacitive sensors, or infrared sensors.

3. The position sensing device of claim 1, wherein the physical pattern layer is formed by printing, engraving, or molding.

4. The position sensing device of claim 1, wherein the physical pattern layer is replaceable.

5. The position sensing device of claim 1, wherein sizes and positions of the independent blocks are equal to sizes and positions of patterns of the physical pattern layer.

6. The position sensing device of claim 1, further comprising a substrate disposed below the sensing area.

7. The position sensing device of claim 6, further comprising a frame disposed on the periphery of the sensing area, wherein the sensors are disposed on the frame.

8. The position sensing device of claim 7, further comprising a buffer layer disposed between the frame and the substrate for damping vibration to protect the sensors.

9. The position sensing device of claim 1, further comprising an elastic sheet coupled with the physical pattern layer.

10. The position sensing device of claim 1, further comprising at least an external switch for inputting at least a signal to the control circuit, wherein the host activates another corresponding command according to the signal.

11. The position sensing device of claim 1, wherein the corresponding command plays pre-stored audio data to make the device as an electronic musical instrument.

12. The position sensing device of claim 1, wherein the corresponding command executes predefined scoring rules to make the position sensing device as a game platform.

13. A position sensing device, comprising:
a plurality of sensors, forming a sensing area to detect characteristic data of a touch object;
a physical pattern layer, combined with the sensing area for dividing the sensing area into a plurality of independent blocks; and
a control circuit, electrically connected to the sensors, for processing the characteristic data detected by the sensors to generate position data of the touch object; and
a processor, coupled to the control circuit, for receiving the position data and activating at least a corresponding command according to the position data relative to the independent blocks.

14. The position sensing device of claim 13, wherein the physical pattern layer is replaceable.

15. The position sensing device of claim 13, further comprising a substrate disposed below the sensing area.

16. The position sensing device of claim 15, further comprising a frame disposed on the periphery of the sensing area; wherein the sensors are disposed on the frame.

17. The position sensing device of claim 16, further comprising a buffer layer disposed between the frame and the substrate for damping vibration to protect the sensors.

18. The position sensing device of claim 13, further comprising at least an external switch for inputting at least a signal to the control circuit, wherein the processor activates another corresponding command according to the signal.

19. The position sensing device of claim 13, further comprising an elastic sheet coupled with the physical pattern layer.

20. The position sensing device of claim 13, wherein the corresponding command plays pre-stored audio data to make the position sensing device as a standalone electronic musical instrument.

21. The position sensing device of claim 13, wherein the corresponding command executes predefined scoring rules to make the position sensing device as a standalone game platform.

22. A position sensing device, comprising:
a plurality of sensors, forming a sensing area to detect characteristic data of a touch object;
a pattern layer, combined with the sensing area for dividing the sensing area into a plurality of independent blocks; and
a control circuit, electrically connected to the sensors, for processing the characteristic data detected by the sensors to generate position data of the touch object, and transmitting the position data to a host;
wherein the host activates at least a corresponding command according to the position data relative to the independent blocks, and the pattern layer is switchable between a physical pattern layer and an electronic pattern layer.

23. The position sensing device of claim 22, further comprising a transparent substrate disposed below the sensing area.

24. The position sensing device of claim 22, wherein the electronic pattern layer is generated by a display connected to the host, and the sensing area is larger than display area of the display.

25. The position sensing device of claim 24, wherein the sensing area is disposed in front of the display area of the display to make the position sensing device as an add-on touch panel.

26. A position sensing device, comprising:
a plurality of sensors, forming a sensing area to detect characteristic data of a touch object;
a control circuit, electrically connected to the sensors, for processing the characteristic data detected by the sensors to generate position data of the touch object, and transmitting the position data to a host; and
at least an external switch, for inputting at least a signal to the control circuit;
wherein the host activates at least a corresponding command according to the position data relative to the independent blocks.

27. The position sensing device of claim 26, wherein the host activates preset command as the control circuit receives signal from the external switch.

28. The position sensing device of claim 27, wherein the sensing area is disposed in front of a display connected to the host to make the position sensing device as an add-on touch panel.
